(19) United States
(12) Patent Application Publication
(10) Pub. No.: US 2004/0004411 A1
(43) Pub. Date: Jan. 8, 2004

(54) Electric motor with acoustic insulation

(76) Inventor: Jean-Luc Andre, Molsheim (FR)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/399,805

(22) PCT Filed: Oct. 17, 2001
(86) PCT No.: PCT/FR01/03213

(30) Foreign Application Priority Data
Oct. 20, 2000 (FR) 00/13498

(51) Int. Cl. H02K 1/22

(52) U.S. Cl. 310/261

(57) ABSTRACT

An electric motor with acoustic insulation of the type of electric motor with external rotor enclosing the stator. The acoustic insulation consists in an acoustic insulation peripheral shield (12) enclosing the outer lateral surface (16) of the rotor made of a material or having a structure providing acoustic attenuation by degenerating sound energy in response to micro-displacements of friction transforming it into heat. The invention is of interest for manufacturers of electric motor.

The instant invention relates to an electric motor with acoustic insulation, particularly for the type of electric motor having an external rotor which surrounds the stator.

Electric motors are valued for their high torque and elevated energy output.

This is also true for electric motors with an exterior rotor surrounding the stator, which have a higher than average energy output.

For this reason, as well as the motor's reduced size and non-polluting qualities, it is the preferred choice in the transportation domain, especially public urban transportation.

Moreover, manufacturers of buses, trams, and other public transportation vehicles that run on electricity prefer to equip the vehicles with an exterior rotor type of electric motor.

Unfortunately, its high performance and other qualities are outweighed by a serious obstacle for the transportation industry: the noise produced at operating speeds. The noise constitutes sound pollution and is considered excessive for use in an urban environment.

Therefore, the goal of the invention is offer an effective, technically simple, and easily implemented solution for significantly reducing the noise produced by these motors at operating speeds.

Other characteristics and features of the invention will be apparent from the following description, provided by way of example and accompanied by drawings which represent:

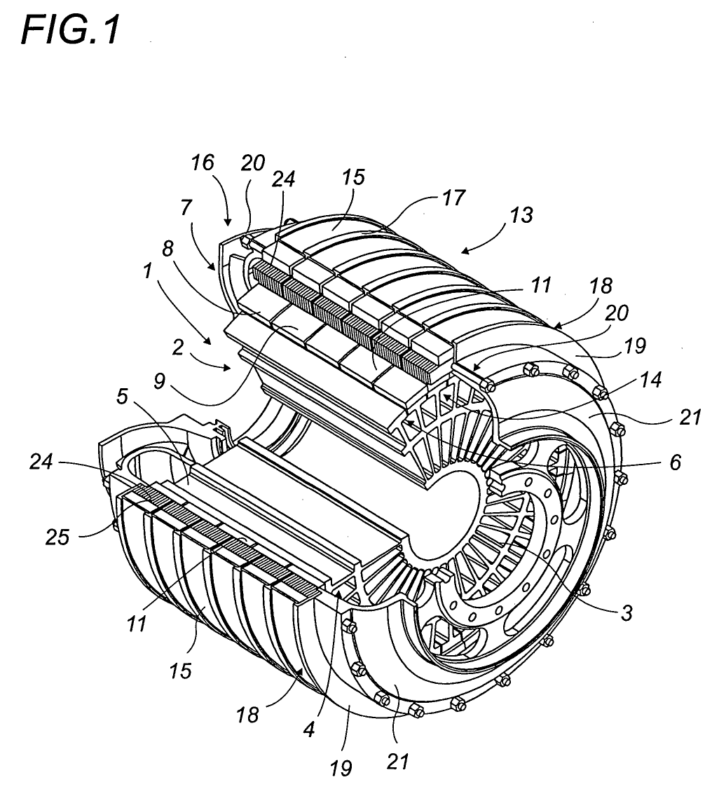

FIG. 1: a perspective view of the entire electric motor having a rotor exterior to the stator, with one portion cut away to show its internal composition according to a first variation;

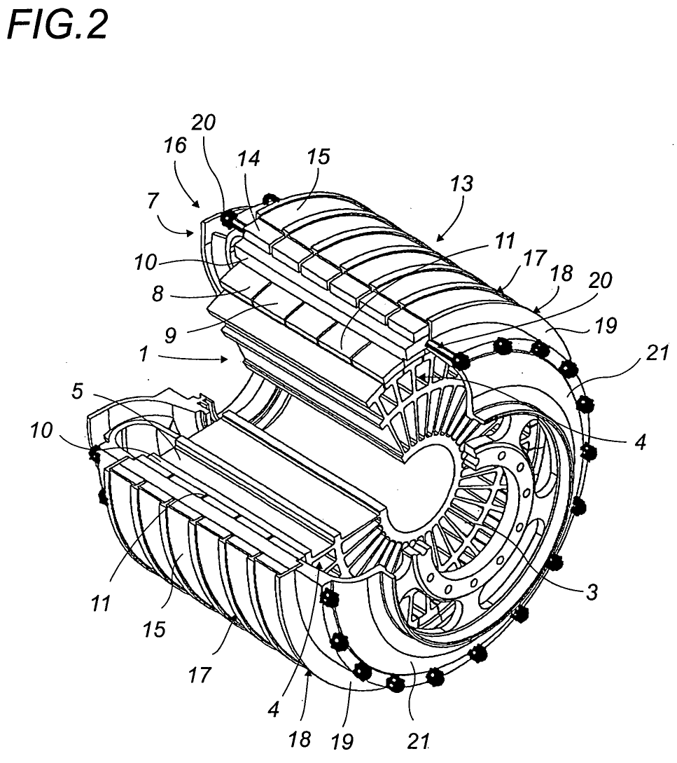

FIG. 2: a perspective view of the entire electric motor having a rotor exterior to the stator, with one portion cut away to show its internal composition according to a second variation;

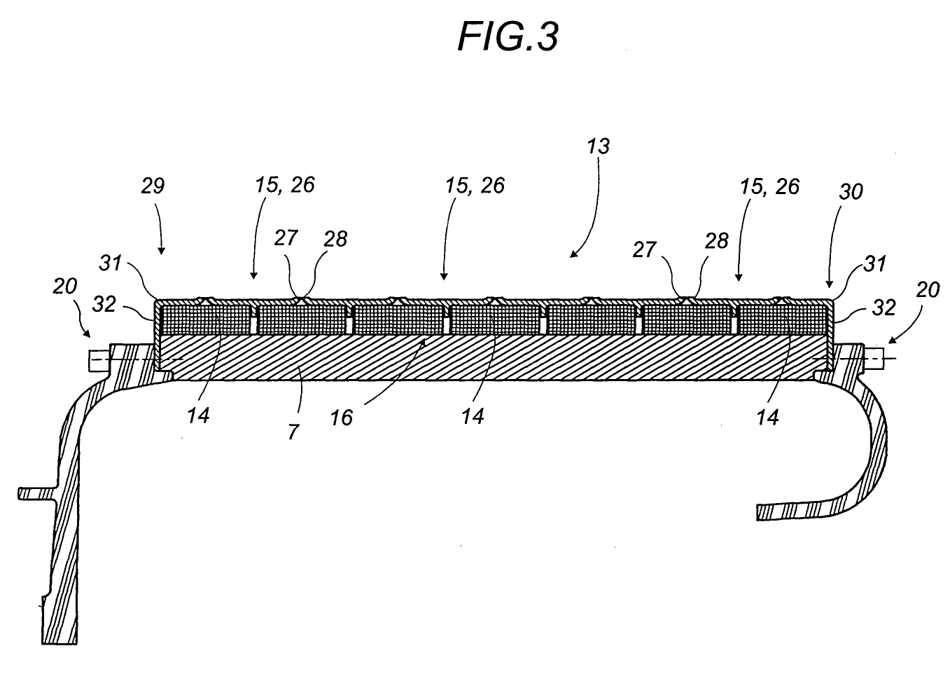

FIG. 3: a partial axial cross-section of the upper portion showing a system for immobilizing the acoustically insulating pads surrounding the rotor;

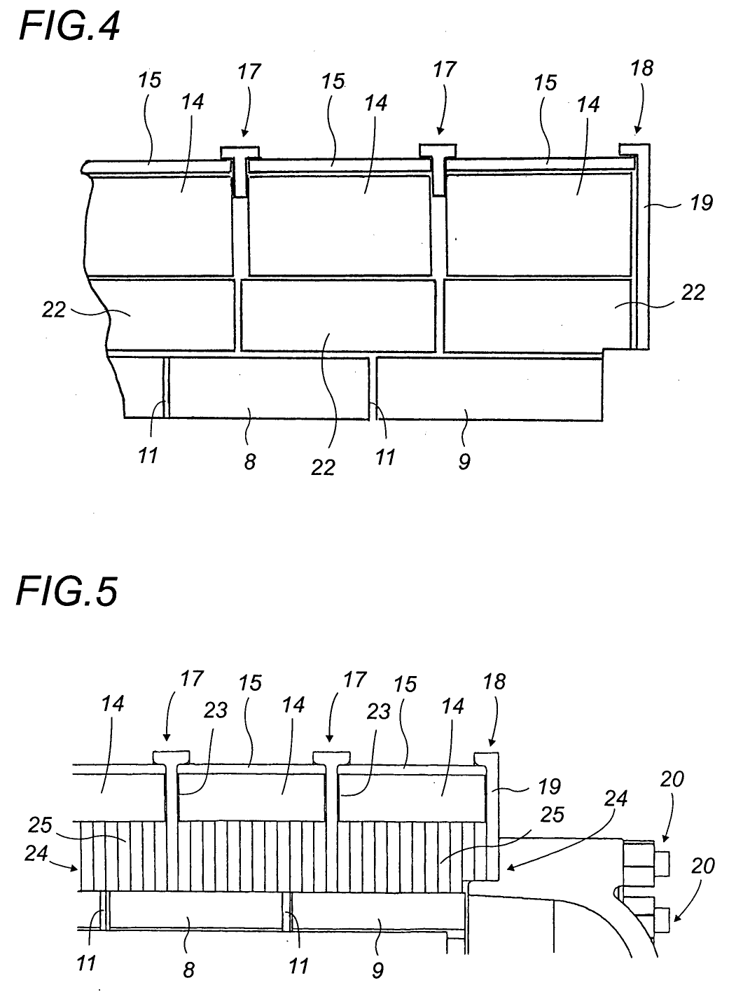

FIGS. 4 and 5: schematic views in partial axial cross-section showing two design variations of rotors having integrated insulation in juxtaposed sections and in a plated structure, respectively;

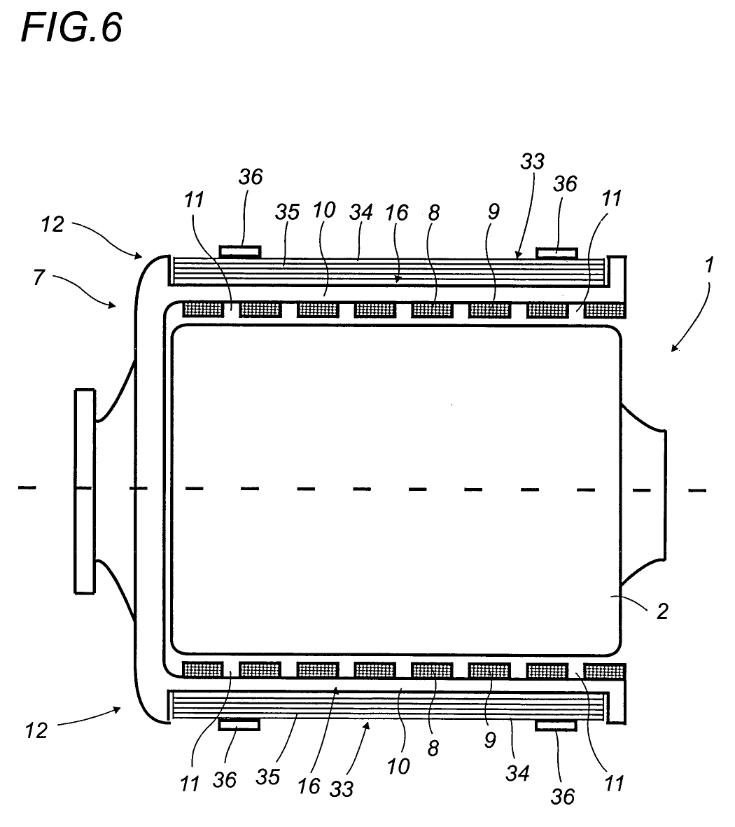

FIG. 6: a longitudinal cross-section of an electric motor according to a variation having insulation consisting of a metal strip or superimposed sheets of metal.

In order to effectively attenuate the operating noise of an electric motor, particularly an electric motor with an exterior rotor surrounding the stator, the general inventive solution proposed by this invention consists of displacing the specific resonance frequency of the mechanical unit while degenerating the audible frequencies of mechanical energy in the critical plane by micro-displacements of friction within a peripheral exterior structure surrounding the rotor which transforms the mechanical acoustic energy into heat.

To achieve this, the body of the exterior motor is surrounded by a structure which transforms the mechanical energy of the vibrations into heat, consisting of acoustic insulation for the specific noise of the motor within the band of audible frequencies.

This peripheral acoustic insulation is a perimeter barrier, hereinafter called the peripheral shield, and it may be in the form of a jacket, padding, or more generally a continuous or discontinuous structure, either simple or composite, surrounding the exterior lateral surface of the rotor.

The shield may consist, for example, of individual juxtaposed acoustically insulating cushions having a composite metal envelope which immobilizes, protects, and compresses them and also evacuates heat to the exterior.

The acoustically insulated electric motor of the invention is preferably an electric motor with a rotor exterior to the stator and with permanent or excitation magnets. The electric motor of this type shown in the drawing is composed of the following main organs and elements:

A stator 1 is formed of a central body 2. It has a hollow body traversed by two cooling channels such as channels 3. The central portion of the body is surrounded by a hollow peripheral coil structure 4 with axial coil channels 5 on stator 1 being separated by T-shaped longitudinal elements which define at their upper portion longitudinal openings 6.

Encasing central body 2 there is a rotor 7 attached with bearings (not shown) consisting of a succession of blocks of permanent magnets such as magnets 8 and 9 which are magnetized alternately in opposition, attached to a peripheral tubular mechanical block 10 which may be a solid mass, made of separate portions, or plates and which, together with magnets 8 and 9, forms the body of rotor 7. The blocks of permanent magnets 8 and 9 extend longitudinally and are insulated by non-magnetic longitudinal separators 11 between the layers.

The unit is surrounded by a peripheral acoustic insulating shield 12 which diminishes noise to the extent desired by degenerating mechanical acoustic energy into heat. This acoustic insulating shield 12 is maintained and protected by an exterior composite metal envelope 13 formed of several pieces and having lateral metal bands maintained by circular exterior portions or belts. This shield may consist, for example, of bands 14 or rows of acoustic insulation blocks 14 each attached to first, the annular metal band maintenance and compression segments 15 and second, the exterior lateral surface 16 of rotor 7 as shown in the drawings.

The following non-limitative examples describe the composition of the various structures for degenerating the energy of mechanical vibrations.

The invention provides structures or materials for degenerating most of the acoustic energy into heat, particularly the energy located in the band of audible frequencies.

First, plated structures consisting of a plurality of plates or superimposed sheets may be used. These plates or sheets are animated in micro-displacements by the acoustic vibrations transmitted to them. The micro-displacements generate dry friction because the structures are flatly superimposed.

Second, a material pre-compressed into narrow bands, packets, blocks, cushions, pads, or other physical shape with a plane or flattened frontal surface may be used. The acoustic insulation material consists of a mass of threads, filaments, small pieces, fibers, thin strips, ribbons, small bands, straws or other flat or filament-like pieces of metal, in mutually overlapping surface contact such that acoustic vibration produces micro displacements of friction in order to degenerate acoustic energy by transforming it into heat. As will be seen below, the packets, blocks, or bands 14 are initially compressed and then disposed uniformly to cover the totality of the exterior lateral surface of the rotor and thus form the acoustic insulation shield 12. These packets, blocks or bands 14 are also compressed against the lateral surface of the rotor by the composite exterior envelope 13 which can be adjusted in order to increase the frictional force which causes the mechanical acoustic energy to degenerate into heat.

It is also possible to use viscous friction by adopting resilient substances or materials to achieve the degeneration of acoustic energy. The shape and compression will be receptive to the effects of resilient friction inside the substance of this material.

The mechanical base of the rotor is a cylindrical body made of one piece or divided into several component pieces with its interior lateral surface equipped with permanent magnets 8 and 9 and its exterior lateral surface 16 being attached to the peripheral acoustic insulation shield 12.

The first description will concern exemplary embodiments using an acoustic insulation material shaped as blocks, packets, pads, cushions, bands or other shapes, all referenced globally by the numeral 14. These variations are illustrated by FIGS. 1 through 5.

The acoustic insulation material described above is compressed into packets, blocks or other shapes 14 adapted for application to the exterior lateral surface 16 of the mechanical base of the rotor to achieve the desire degree of acoustic insulation.

The adapted shapes 14 formed by the insulation material are positioned flat against this exterior lateral surface 16 and then forced into contact and pressed against it by immobilization and maintenance means which also are used for protection and heat dissipation.

The adapted shapes 14 are disposed in linear longitudinal and lateral succession, thus defining the annular portions of the peripheral surface. These annular portions are pressed against the lateral surface 16 of the rotor and covered by annular segments 15 of metal sheets immobilized by maintenance rings such as rings 17 or hoop elements (FIGS. 1 and 2) that are adjusted to produce the necessary pressure and restraint while the motor is in use.

These maintenance rings or hoops 17 may extend radially forming partitions which separate two annular portions of the peripheral layer and the rotor pieces and eventually the magnets, as will be seen below.

The extremities of shield 12 are covered by edgewise maintenance rings 18 in the form of an annular end flange 19 providing lateral protection and ensuring lateral maintenance.

Clamps 20 are provided for laterally maintaining the pieces that constitute rotor 7 and the pieces of the composite exterior envelope 13, as well as for fixation of the flanges, such as flanges 21 on the ventilation turbines which laterally close the mechanical block of the electric motor.

Another version is possible wherein a tubular body 10 forming the mechanical base of rotor 7 consists of tubular portions or segments 22 which are as long as the width of the layer of acoustic insulation rings (FIG. 4). According to this variation, the maintenance rings or hoops 17 extend downward into radial separation and partition elements 23 forming rings which act as partitions between the blocks of acoustic insulation material 14 and which in some cases extend further downward and form similar separations between tubular portions 22.

This arrangement permits assembly by stacking, with clamps 20 used for tightening.

The same type of assembly and arrangement occurs in the case of a mechanical rotor base have a plated structure 24 formed of stacked metal flanges 25 shaped like rings, as shown in FIG. 5.

Note in this drawing that the radial extensions 23 separating the maintenance rings or hoops 17 extend across the plated structure 24 of the rotor forming successive individual groups that are compressed by tightening clamps 20.

This structural formation is also visible in FIG. 1 which shows the stacking that forms a block with a plated structure 24 constituting a new type of rotor.

According to a simplified variation of improved design, extensions 23 of maintenance rings or hoops 17 extend radially for a shorter distance, advancing only slightly. This arrangement is advantageous because the exterior rotor can be covered without modifying it.

In a variation such as this, shown in FIG. 3, the annular segments maintaining and covering exterior envelope 13 are simply juxtaposed.

Each annular segment 26 covering exterior envelope 13 has a generally annular shape and is T-shaped, with lateral longitudinal edges 27 and 28 raised to facilitate the lateral introduction of acoustic insulation blocks 14. End segments 29 and 30 have a shoulder 31 and a downward extending return 32 so the upper edges of the motor block can be covered and for laterally closing the acoustic insulation structure. The vertical branch of the T-shaped portion limited to its minimal length ensures lateral separation between the rows of blocks or bands 14 of acoustic insulation material on the exterior lateral surface 16 of rotor 7. It also ensures that blocks or bands 14 are permanently laterally compressed by compressing them laterally with clamps 20.

This structure and this arrangement allow the rotor and its integrated acoustic insulation to be quickly and easily assembled.

Assembly is accomplished by laterally threading, alternately and in succession, one by one, the tubular portions or groups of annular flanges and the rows or bands of acoustic insulation material, then pushing them laterally each time by the next tubular portion 22 or group of flanges 25 until all the constituent elements are positioned and thus the mechanical sound vibrations are transformed into heat.

The diameter of these tubular portions 22 in relation to that of lateral exterior rotor surface 16 is selected to ensure that acoustic insulating blocks 14 are permanently compressed in order to improve the friction effect of the filaments or ribbons constituting the insulating material.

Annular segments 15 or 26 covering exterior envelope 13 are made of metal not only to provide mechanical protection, but also to evacuate heat to the outside.

It is important to note that in the arrangements described above, a number of pieces are not connected to one another, but simply clamped into place. Under these conditions, relative micro-displacements of friction are possible, thereby increasing the transformation of acoustic energy into heat.

According to a variation shown in FIG. 6, the rotor body has an exterior lateral surface 16 that forms a concave annular surface designed to serve as a receptor cavity for an acoustic insulation structure 33, for example, a plated metal structure.

The plated metal structure 33 may, as shown, consist of a metal strip 34 wound several times, the coils of the strip being joined. These coils undergo relative micro displacements in order to degenerate mechanical acoustic energy into heat.

The plated metal insulating acoustic structure 33 may also be formed of several distinct superimposed sheets or metal plates 35 which also undergo relative micro-displacements.

The strip, the sheets and the plates are maintained by several peripheral connectors 36 which are preferably flat, for example, straps, belt, hoops, or any other equivalent means.

1. An acoustically insulated electric motor of the type having a rotor (7) external to the stator (1), characterized in that the lateral exterior surface (16) of the mechanical rotor unit (7) is surrounded by a peripheral shield (12) of acoustic insulation covered with a protective exterior composite metal envelope (13), said shield (12) being formed of a jacket or padding of material or a structure and which cooperates with the other non-interconnected pieces of the rotor to degenerate mechanical acoustic energy into heat, at least within the band of audible frequencies, by transforming it with friction into heat evacuated to the exterior through the protective exterior composite metal envelope (13) which surrounds the shield in order to maintain, protect, and compress it and to evacuate heat.

2. An electric motor according to claim 1 characterized in that the transformation of mechanical acoustic energy into heat is effected through frictional contacts following micro-displacements within the core of the material or the structure of the acoustic insulation.

3. An electric motor according to claim 1 or 2 characterized in that the friction is dry friction.

4. An electric motor according to claim 1 or 2 characterized in that the friction is viscous friction.

5. An electric motor according to the preceding claim characterized in that the component of the acoustic insulating material is a resilient material in a physical form that allows friction during mutual contact.

6. An electric motor according to any one of preceding claims 1 through 3 characterized in that the acoustic insulation shield (12) is a padding formed by the juxtaposition of packets, blocks, pads, cushions, or thick bands (14) of an acoustic insulation material.

7. An electric motor according to the preceding claim characterized in that the acoustic insulation material is formed of straws, fibers, threads, filaments, thin strips, ribbons, small metal bands, or any other flat or flattened shape, one or the other of these physical metal shapes being bound together and compressed and then formed into blocks or thick bands (14).

8. An electric motor according to preceding claims 6 or 7 characterized in that the blocks are covered by an exterior composite metal envelope (13) for maintenance, protection, and heat evacuation formed of annular metal segments each attached between two maintenance rings or hoops (17).

9. An electric motor according to the preceding claim characterized in that the exterior metal envelope (13) is divided into several annular segments (15) or (26) which are simply juxtaposed and maintained by pressure from the hoops (17).

10. An electric motor according to the preceding claim characterized in that the hoops (17) extend downward into radial partition extensions.

11. An electric motor according to the preceding claim characterized in that the rotor (7) consists of stacked annular metal flanges (25) divided into groups by the radially extending partitions (23) of the hoops (17).

12. An electric motor according to claim 10 characterized in that the rotor (7) consists of a lateral succession of tubular portions or segments (22).

13. An electric motor according to the preceding claim characterized in that the rotor (7) consists of a lateral succession of tubular portions or segments (22) separated by the radially extending partitions (23) of the hoops (17).

14. An electric motor according to claim 9 characterized in that the longitudinal rims of the annular segments (15) or (26) covering the exterior envelope (13) are raised.

15. An electric motor according to claim 9 characterized in that the annular segments (15) or (26) covering the exterior envelope (13) are T-shaped, with the vertical branch serving as a separator between blocks, packets, bands, or other shape (14) formed by the acoustic insulation material.

16. An electric motor according to either preceding claim 1 or claim 2 characterized in that the peripheral acoustic insulation shield (12) is a plated metal structure (33) surrounding the rotor (7).

17. An electric motor according to the preceding claim characterized in that the plated metal structure (33) consists of a metal strip (34) wound several times with the coils of the strip being joined.

18. An electric motor according to claim 16 characterized in that the wound strip is formed of several distinct and superimposed sheets or metal plates (35).

19. An electric motor according to any one of preceding claims 16 through 18 characterized in that the strip, the sheets or the plates (35) are maintained by several peripheral connectors (36).

20. An electric motor according to the preceding claim characterized in that the peripheral connectors (36) are flat connectors such as hoops, straps, belts, or the like.
